(19) United States
(12) Patent Application Publication
(10) Pub. No.: US 2016/0257037 A1
(43) Pub. Date: Sep. 8, 2016

(54) METHOD OF SCULPTING CAKE ICING AND THE LIKE

(71) Applicant: Mayra Estrada, Granada Hills, CA (US)

(72) Inventor: Mayra Estrada, Granada Hills, CA (US)

(21) Appl. No.: 14/636,772

(22) Filed: Mar. 3, 2015

(51) Int. Cl. B29C 41/12

(52) U.S. Cl. CPC B29C 41/12; B29K 2005/00; B29L 2009/005

(57) ABSTRACT

A method of decorating a cake or similar confection having an icing layer or the like. A tool having interchangeable heated styluses is pressed into the icing layer, thereby melting or ablating the icing, or both melting and ablating. The stylus may be drawn along the icing layer to impart pictorial elements, such as decorative lines, patterns, recesses, shapes, and indicia. The amount of heat of the stylus may be adjusted. The cake or confection may be conventionally adorned before or after stylus treatment, for example with pigments, incorporation of simulated objects such as flowers, addition of extruded icing, etc.

### FIELD OF THE DISCLOSURE

The present disclosure relates to a method of decorating cakes and other confections having fat bearing coatings of the type known as icing, the method comprising ablating the icing with heat.

### BACKGROUND

There exists demand for customized cakes and like confections, wherein the cake is coated with icing. In the present application, the term icing will be used to collectively refer to ganache, icing, fondant, butter cream, whip cream, frosting, royal icing, marzipan, sugar paste, flower past, petal paste, gum paste, Mexican paste, modelling paste, pastillage, glace icing, and the like. Customization may take the form of building up the icing coating, including using different colors. The traditional approach to modifying a coating of icing has been to extrude additional icing from a dispenser having a specially shaped discharge nozzle. For example, borders, designs, and indicia can be superimposed over backgrounds of one color, with the subsequently added visual elements being of the same color or of different color.

Methods for coloring artwork (objects, abstract designs, raised borders demarcating zones on the exterior of a cake, indicia, etc.) have also been proposed. Specialized equipment for printing onto cakes and transferring optically discernible patterns on cakes have been proposed.

There remains a need for improved ways of carving or sculpting icing for cakes and other confections.

### SUMMARY

The disclosed concepts address the above stated need by providing a method of modifying a layer of icing on a cake, or the like, by scultping the layer of icing. A heated stylus, which is interchangeable, of a tool is held against the icing. The icing is ablated thereby, or melted, or both ablated and melted. Many different patterns and designs can be recessed into the layer of icing with the use of different heated styluses as each heated stylus can impart a different pattern/design. Designs may be formed totally by heat sourced ablation. Alternatively, designs imposed on the layer of icing may be modified by addition of conventional cake decoration elements, such as simulated flowers, edible paints, and the like.

It is an object of the invention to provide improved elements and arrangements thereof by apparatus for the purposes described which is inexpensive, dependable, and fully effective in accomplishing its intended purposes.

This and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side view of a cake being decorated, according to at least one aspect of the disclosure;

FIG. 2 is a block diagram of a method of treating the icing layer of the cake of FIG. 1, according to further aspects of the disclosure.

### DETAILED DESCRIPTION

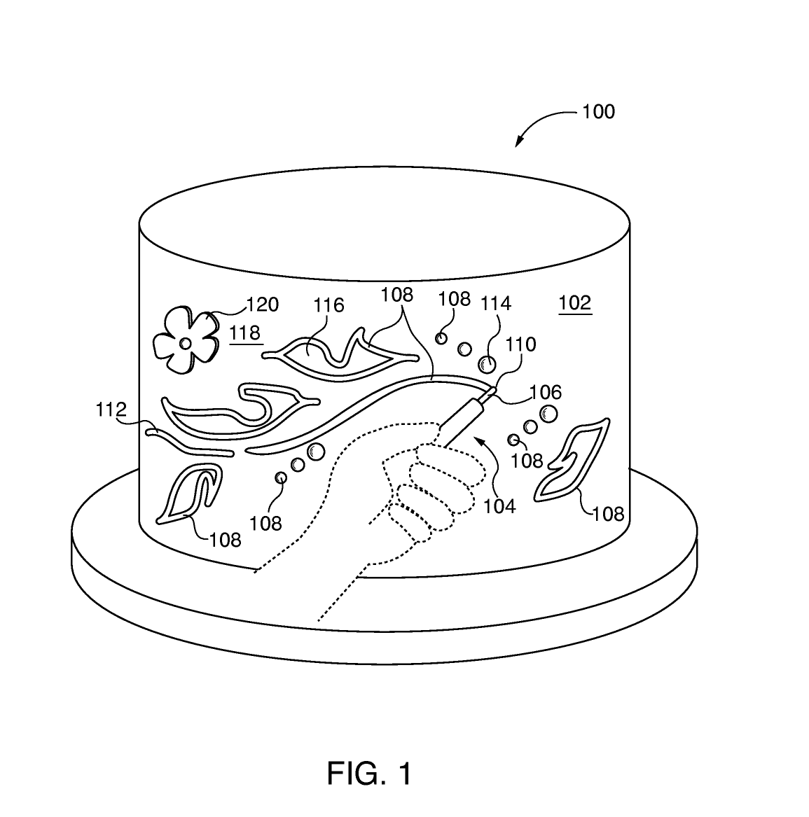

Referring first to FIG. 1, according to at least one aspect of the disclosure, there is shown a cake 100 having an icing layer 102. Icing applied to cake 100 as a coating, also popularly known as frosting, will be understood to comprise a viscous or creamy glaze including at least one liquid, such as water or milk, typically a sweetener such as cane sugar, and typically fats, such as butter, cream cheese, glycerine, and liquid fats. Icing may include thickening agents such as gelatin, egg whites, and others. Icing typically contains flavorings, such as vanilla extract, cocoa, and others. Granular or comminuted particles, such as colored sprinkles, crushed nuts, etc., may be used on icing. Listed ingredients and components of icing layer 102 are not shown.

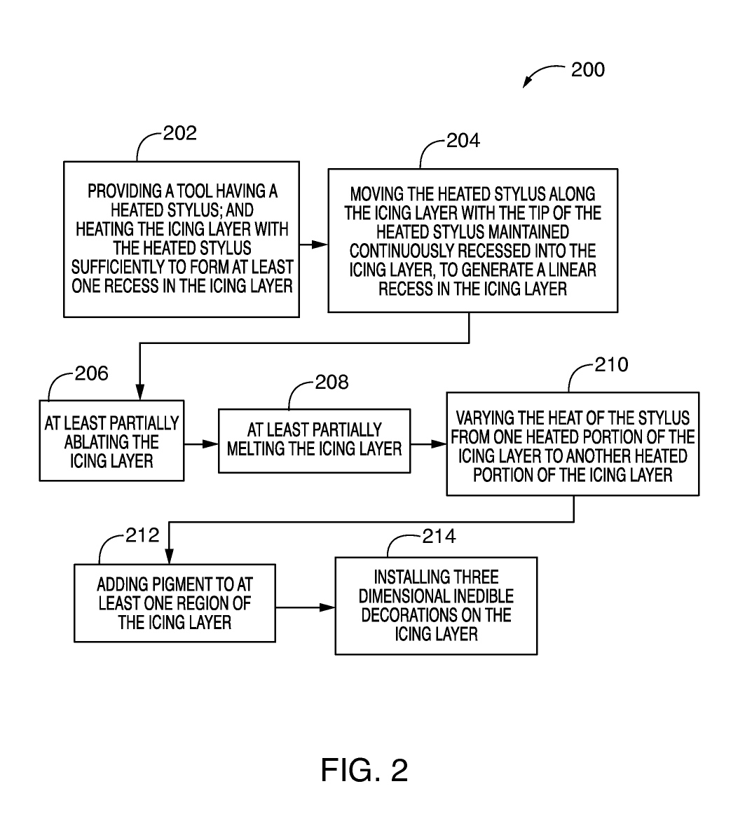

Cake 100 may be adorned at least by imparting pictorial devices such as recessed holes, lines, and indicia. More specifically, there is disclosed a method 200 of treating the icing layer 102 on the confection, comprising providing a tool 104 having a heated stylus 106; and heating icing layer 102 with heated stylus 106 sufficiently to form at least one recess 108 in icing layer 102 (see block 202 in FIG. 2). Heating icing layer 102 rather than conventionally carving may result in eliminating displaced icing, which otherwise might come to be deposited on icing layer 102, thereby potentially impairing sharpness of lines and edges formed in icing layer 102.

Tool 200 may be any hand held tool having heated tip or stylus 106. Examples include products manufactured by Colwood Industries of Farmingdale, N.J. 07727. Some products include Colwood Industries' 0500-RT Handle Ball Tip Package for Replaceable Tips, product identification 500; Ball Tip Package for Replaceable Tips, product identification BTPR; and Circle Tip Package for Replaceable Tips, product identification CTPR. The above tools may be used with control units manufactured by Colwood Industries, including Cub, product identification 2000; Cub/HD Cord, product identification 2000H; and Detailer with HD 16 Gauge Cord, product identification 2001H. Additional tools and control units are available from Colwood Industries.

In method 200, heating icing layer 102 with heated stylus 106 further comprises moving heated stylus 106 along icing layer 102 with the tip 110 of heated stylus 106 maintained continuously recessed into icing layer 102, to generate a linear recess in icing layer 102 (block 204 in FIG. 2). By this expedient, relatively long ornamental designs may be imparted into icing layer 102.

In method 100, heating icing layer 102 with heated stylus 106 comprises at least partially ablating icing layer 102 (block 206 in FIG. 2). Alternatively, or in addition to at least partially ablating icing layer 102, in method 100, heating icing layer 102 with heated stylus 106 comprises at least partially melting icing layer 102 (block 208 in FIG. 2). Ablating icing layer 102 results in removal of some of icing layer 102, without spatter or deposition of displaced icing elsewhere on icing layer 102. Melting icing layer 102 may cause displaced icing to be absorbed into a condensed or thickened portion of icing layer 102, again without spatter or deposition of displaced icing elsewhere on icing layer 102.

Method 200 may further comprise varying the heat of heated stylus 106 from one heated portion (e.g., recess portion 112) of icing layer 102 to another heated portion (e.g., recess portion 114) of recess 108 (see block 210 in FIG. 2). For example, additional heat may increase depth and width of recess 108.

Cake 100 may be conventionally adorned in addition to treatment of icing layer 102 according to method 200, before or after treatment, or alternatively, partially before treatment and partially after treatment. In one example of adornment, method 200 may further comprise adding pigment to at least one region 116 of icing layer 102 (see block 212 in FIG. 2). Cake 100 may thus have differently colored regions 116, 118 for further aesthetic effect. In another example of adornment, method 200 may further comprise installing three dimensional, inedible or edible, decorations (e.g., simulated flower 120) on icing layer 102 (see block 214 in FIG. 2). Effectiveness of adorning cake 100 may be enhanced by combining the above conventional elements with recesses 108 having sharp edges and definition resulting from heat treating icing layer 102 by heat, as described above.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A method of treating an icing layer on a confection, comprising:
providing a tool having a heated stylus; and
heating the icing layer with the heated stylus sufficiently to form at least one recess in the icing layer.

2. The method of claim 1, wherein heating the icing layer with the heated stylus further comprises moving the heated stylus along the icing layer with the tip of the heated stylus maintained continuously recessed into the icing layer, to generate a linear recess in the icing layer.

3. The method of claim 1, wherein heating the icing layer with the heated stylus comprises at least partially ablating the icing layer.

4. The method of claim 1, wherein heating the icing layer with the heated stylus comprises at least partially melting the icing layer.

5. The method of claim 1, further comprising varying the heat of the stylus from one heated portion of the icing layer to another heated portion of the icing layer.

6. The method of claim 1, further comprising adding pigment to at least one region of the icing layer.

7. The method of claim 1, further comprising installing three dimensional inedible decorations on the icing layer.

8. The method of claim 1, wherein the icing layer comprises a ganache.

9. The method of claim 1, wherein the icing layer comprises a fondant.

10. The method of claim 1, wherein the icing layer comprises a frosting.

11. The method of claim 1, wherein the icing layer comprises a butter cream.

12. The method of claim 1, wherein the icing layer comprises a sugar paste.

13. The method of claim 1, wherein the icing layer comprises a marzipan.

14. The method of claim 1, wherein the icing layer comprises a flower paste.

15. The method of claim 1, wherein the icing layer comprises a modelling paste.

16. The method of claim 1, wherein the icing layer comprises a pastillage.

17. The method of claim 1, wherein said tool has a plurality of interchangeable styluses having various shapes, and wherein each of said plurality of interchangeable styluses generates a different impression to said confection.
